(19) United States
(12) Patent Application Publication
(10) Pub. No.: US 2018/0345877 A1
(43) Pub. Date: Dec. 6, 2018

(54) ILLUMINATED BADGE

(71) Applicant: Gerhardi Kunststofftechnik GmbH, Luedenscheid (DE)

(72) Inventor: Dirk KIESLICH, Plettenberg (DE)

(73) Assignee: Gerhardi Kunststofftechnik GmbH, Luedenscheid (DE)

(21) Appl. No.: 15/780,038

(22) PCT Filed: Jan. 18, 2017
(86) PCT No.: PCT/EP2017/051008

§ 371 Date: May 30, 2018

(30) Foreign Application Priority Data
Jan. 18, 2016 (DE) 20 2016 000 238.5

(51) Int. Cl. B60R 13/00; G09F 21/04; B60Q 1/26; B60Q 1/50; G09F 13/04

(52) U.S. Cl. CPC B60R 13/005; G09F 21/048; B60Q 1/2661; G09F 2013/044; B60Q 1/503; G09F 13/0413; B60Q 1/2615

(57) ABSTRACT

A fully or partially illuminated badge, preferably for use in the interior and exterior in the motor vehicle industry, includes a transparent lens that is combined with an illumination source and a support piece, which is subsequently rear-mounted, such that an assembly is formed.

The invention relates to a brand emblem that is illuminated over its full area or in part, preferably for use in the interior as well as in the exterior in the automotive sector.

In the automotive sector, a distinction is made between the inside region of the vehicle, called the interior, and the outside region of the vehicle, called the exterior. The illuminated brand emblems being considered here are increasingly being used in the automotive sector in order to ensure brand recognition even during dusk or complete darkness, or for what are called coming-home functions, in which multiple exterior elements, including the brand emblem, are illuminated when approaching and opening the vehicle, for example in order for the user to make it easier to find his/her vehicle, for example in large parking lots or in parking garages.

Decorative elements are known from the documents DE 10 2014 015 185 and DE 20 2009 012 788, which describe embodiments of an illuminated brand emblem. In DE 10 2014 015 185, the illumination is disposed behind the chrome-look decorative element and the light is cast onto the support component that lies behind and holds the decorative element. In DE 20 2009 012 788, the chrome-look decorative element is illuminated directly from behind. However, both embodiments have the disadvantage that they provide a component in which the light production meets the requirements only when looked at directly from the front, but when viewed at an angle that is offset, from the side, the geometrical structure of the brand emblem covers illuminated regions produced by the light.

Neither of the embodiments fulfills the trend in the automotive industry that demands illuminated brand emblems that can be seen regardless of the viewing angle of the light-produced regions.

Against this background, the invention is based on the task of making available a brand emblem that is illuminated over its full area or in part, which can be used in the interior as well as in the exterior, independent of the viewing angle, and preferably has a compact structure, can be produced as a composite, and makes it possible to implement delicate variable contour light solutions. According to the invention, this task is accomplished with the characteristics of claim 1.

With the invention, a brand emblem that is illuminated over its full area or in part is created, which can be used in the interior as well as in the exterior, independent of the viewing angle, and preferably has a compact structure, can be produced as a composite, and makes it possible to implement delicate variable contour light solutions. By means of the use of the lens, optical effects can be created, which bring about a three-dimensional appearance of the brand emblem, but at the same time have a very flat structure and thereby also allow recognition of the contour of the brand emblem even when viewed from the side.

Experience has shown that brand emblems as they are used in the automotive industry, for example, are formed from chrome-look elements. Chrome-look elements as brand elements generally impart great worth and a long useful lifetime. Galvanically decorated elements composed of plastic are most commonly in use nowadays, but chrome-look imitations on the basis of metal deposition such as PVD, PECVD, CVD or vacuum vapor deposition on plastic components are also in use. Chrome-look coatings on films, which are subsequently formed in terms of their contour and laminated in-mold, are possible. Likewise, chrome-look paint coatings are possible, with restrictions. Use of actual metal foils is also conceivable.

In the following, the invention will be explained in greater detail using different variants of the brand emblem according to the invention, wherein:

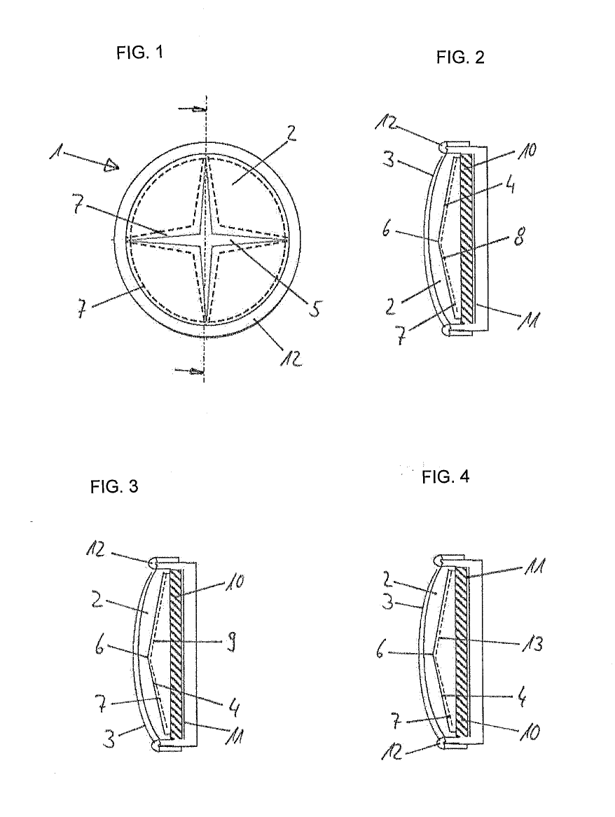

FIG. 1 in schematic representations, the front view of a brand emblem;

FIG. 2 a sectional side view of the brand emblem shown in FIG. 1, which is illuminated over its full area or in part;

FIG. 3 a sectional side view of the brand emblem shown in FIG. 1, which is illuminated over its full area or in part, in a different embodiment;

FIG. 4 a sectional side view of the brand emblem shown in FIG. 1, which is illuminated over its full area or in part, in a further embodiment;

In the exemplary embodiment, the component, on the view side, is selected to be an illuminated brand emblem 1. It comprises a transparent lens 2 composed of a preferably amorphous plastic such as polyamide (PA), polymethylmethacrylate (PMMA) or, particularly preferably, polycarbonate (PC), produced using injection compression, preferably injection-molding. In the exemplary embodiment, an additional coating 3 is provided on the lens 2, in order to achieve better resistance to influences from the environment and/or media.

In the exemplary embodiment, the lens 2 is provided with a convex surface on the view side. As a modification of the exemplary embodiment, however, the surface can be configured to be concave or flat, depending on the desire of the vehicle manufacturer. On the back side, the lens 2 is provided with a depression 4 in accordance with the contour of the brand emblem 1, which has the shape of a star in the exemplary embodiment. In terms of its geometrical configuration, the contour is produced to be clearly flatter than a conventional decorative element according to the state of the art, since the view of the observer through the lens imparts a greater three-dimensional impression.

A metal-look or chrome-look coated decorative element 5 is held by the back-side depression 4 of the lens 2. The decorative element 5 can be laid into or glued into the depression 4. The chrome-look coating 6 of the decorative element 5 can be structured in such a manner that light can pass through it directly. Deposition technologies such as PVD, PECVD, CVD, and vacuum vapor deposition, as well as paint-coating techniques, are particularly suitable for this. Application of the chrome-look coating 6 is also possible by means of transfer of a metallic or metal-look layer by means of a thermal transfer method. On the view side, a high-quality impression is given by looking through the transparent lens 2 onto the coated decorative element 5. Likewise, the lens 2 protects the decorative element 5, and for this reason, surface coatings on the decorative element 5 that would otherwise be unstable, for example sensitive to scratching, are possible.

However, the decorative element 5 can also be a galvanized component, wherein galvanization over the full area or an actual metal foil applied to a support component is unsuitable for direct illumination, since an actual metal and a galvanic deposition are opaque for light.

In this case, the regions around the back-side depression 4 of the lens 2 are provided with a paint coat or a coating 6, which are configured to be illuminable or opaque. Depending on the configuration of the coating 6 of the decorative element 5 and of the back side of the lens 2, light opacity, partial or full-area illumination of the brand emblem 1 as well as contour illumination or corona illumination 7 can be produced.

For the configuration of the contour illumination or corona illumination 7 around the chrome-look decorative element 5, either the back-side surface of the lens 2 is painted, with the exception of the back-side depression 4 for holding the decorative element 5, wherein the surfaces to be illuminated are produced to be translucent, and the non-illuminated surfaces are produced to be opaque. Production by means of a film 8 that is compatible with the lens material and is laid onto the back side or laminated in-mold is particularly preferred. This film, configured in this manner, is preferably produced by means of painting or imprinting, preferably by means of screen printing. The region of the accommodation of the decorative element 5 is excluded in this embodiment.

In the case of contour illumination or corona illumination 7, the region directly adjacent to the decorative element 5 is translucent, whereas the other regions are opaque. Consequently, the contour of the decorative element 5 can be reproduced by the light and therefore the decorative element 5—the star, in the figures—can be reproduced during darkness.

For production of a chrome-look decorative element 5 without an additionally mounted and decorated component, it is also possible to provide the depression 4 on the back side of the lens 2 directly with a chrome-look paint or a coating 6. Then, the decorative element 5 is imitated by the coating 6 or the chrome-look paint, which is applied to the back-side depression 4 of the lens 2. The coating 6 can be applied using known methods such as PVD, PECVD, CVD or vacuum vapor deposition. On the view side, here the impression of an additional chrome-look decorative element 5 would be formed. In this case, it is advantageous to previously decorate the back side of the lens 2 around the back-side depression 4 of the lens 2; this advantageously takes place by means of imprinting, painting, or, particularly preferably, by means of a film 8 that leaves out the region of the depression 4. The chrome-look coating can then subsequently be produced without masking. A contour illumination or corona illumination 7 can also be implemented in this variant, in that the region directly adjacent to the decorative element 5 is configured to be translucent, whereas the other regions are opaque. Consequently, the contour of the decorative element can be reproduced by the light and therefore the decorative element 5—the star, in the figures—can be reproduced during darkness.

The film 8 discussed above is laid into or laminated in-mold into the back-side depression 4 of the lens 2. It contains a recess that follows the contour of the decorative element 5. The coating of this film establishes the regions that can and cannot be illuminated; it can be translucent in certain regions.

As a modification of the exemplary embodiment, the possibility also exists of laying a coated film in with an additional chrome-look film 13 or to laminate it in-mold. This film 13 then represents the decorative element 5 by itself. It is shaped in terms of its contour and follows the back-side depression 4 of the lens 2.

In a further modification, it is also possible to integrate the chrome-look decorative element 5 directly into the film 9. For this purpose, the film 9 is imprinted, either first or as a second step, around the decorative element 5, wherein the regions that are produced to be opaque and translucent, in other words allowing light to pass through, are established by way of the printing technique. The production of the chrome-look decorative element 5 can be implemented by means of printing, painting, preferably screen-printing with a chrome-look paint. The film, generally coated in sheets, is subsequently shaped and punched out in accordance with the back-side geometry and the depression of the lens. The film 9, provided in this way, is then either laid behind the lens 2 or glued to it, or also directly and non-releasably connected with the lens 2 by means of plastic injection-molding.

An illumination source 10 is provided on the back side of the lens 2, which source is disposed on a support part 11. The illumination source 10 and the support part 11 are combined with the lens 2 to produce a component group. In the exemplary embodiment, chrome-look elements 12 in the form of covers or frames are disposed to surround the lens 2.

During the in-mold lamination using plastic injection-molding, the film insert 8, 9, and 13 provided with the paint pigments is laid into a mold, and the plastic material is introduced in the flowable state. The film 8, 9, and 13, positioned in the mold cavity, is precisely shaped in accordance with the progression of the mold, in this regard, wherein the plastic material forms a non-releasable component with the film insert and the paint pigments after solidification or hardening.

Subsequently, the illumination unit 10 in the form of a light-uncoupling light guide is placed behind this composite. The use of an electroluminescence film is also conceivable. In the non-illuminated state, only the chrome-look decorative element 5 can be seen on the view side through the transparent lens 2, in color surroundings, while when the light is turned on, the regions that are specifically produced to be translucent permit light to pass through.

Finally, to protect the decoration and the electronics required for illumination, a further component, as a support component 11, is set behind the composite described, in other words the lens 2, the chrome-look decorative element 5, and the illumination unit 10, and they are preferably connected with one another by means of welding or gluing, so as to be dust-tight and water-tight.

Using the method according to the invention as described, it is possible to produce a brand emblem 1 that is illuminated over its full area or in part, on the view side, in simple and elegant manner, in only a few production steps.

Installation of further chrome-look elements 12, for example circumferentially around the lens 2, is carried out by means of known and conventional installation methods. However, the ring can also be produced directly with the transparent lens 2, using multi-component injection-molding, wherein the subsequent decoration is only provided on the ring.

In the method according to the invention, not only are different method steps eliminated as compared with the state of the art. Instead, the finished product is particularly characterized in that the brand emblem 1, which is illuminated over its full area or in part, can also withstand great mechanical stresses by means of combining the different plastic materials.

The contour is clearly made to be flatter, in terms of its geometrical configuration, than a conventional decorative element according to the state of the art, since the view of the observer through the lens imparts a greater three-dimensional impression. While decorative elements according to the state of the art usually have a height of approximately 10 mm, the height of the decorative element 5 according to the invention merely amounts to 2 to 3 mm. Consequently, the contour of the decorative element is also not covered in certain regions when looking at the brand emblem from the side, but rather is completely visible. Because of the rounded shape of the lens on its view side, a significantly deeper three-dimensional effect of the decorative element 5 is brought about than is actually the case.

1. A brand emblem that is illuminated over its full area or in part, preferably for use in the interior as well as in the exterior in the automotive sector, which has a transparent lens (2), which is combined, together with a support part (11) that is subsequently mounted on the back side and an illumination source (10), to form a component group.

2. The brand emblem (1) that is illuminated over its full area or in part, according to claim 1, wherein the lens (2) has a coating (3) on the view side.

3. The brand emblem (1) that is illuminated over its full area or in part, according to claim 1, wherein a metal-look decorative element (5) is held by a back-side depression (4) of the lens (2).

4. The brand emblem (1) that is illuminated over its full area or in part, according to claim 1, wherein depending on the configuration of the coating of the decorative element (5) and of the back side of the lens (2), opacity or partial or full-area illumination as well as contour illumination or corona illumination (7) can be produced.

5. The brand emblem (1) that is illuminated over its full area or in part, according to claim 1, wherein a chrome-look paint or a coating (6) is applied to the back-side depression (4) of the lens (2), which paint or coating is produced to be translucent and imitates the metal-look decorative element (5).

6. The brand emblem (1) that is illuminated over its full area or in part, according to claim 1, wherein the regions around the back-side depression (4) of the lens (2) are given a paint coating or coating (6) that is produced to be translucent or opaque.

7. The brand emblem (1) that is illuminated over its full area or in part, according to claim 1, wherein the back-side depression (4) of the lens (2) holds a metal-look decorative element (5).

8. The brand emblem (1) that is illuminated over its full area or in part, according to claim 1, wherein a coated film (8) is laid into or laminated in-mold onto the back side of the lens (2), which film contains a recess that follows the contour of the decorative element (5), and the coating of this film establishes the regions that can and cannot be illuminated.

9. The brand emblem (1) that is illuminated over its full area or in part, according to claim 1, wherein a coated film (9) having an additional chrome-look coating (9) is laid in or laminated in-mold, which film represents the decorative element (5) and is shaped in terms of contour and follows the back-side depression (4) of the lens (2), and the coating of this film establishes the regions that can and cannot be illuminated.

10. The brand emblem (1) that is illuminated over its full area or in part, according to claim 1, wherein in addition, chrome-look elements (12) in the form of covers or frames are affixed.

11. The brand emblem (1) that is illuminated over its full area or in part, according to claim 1, wherein a film (13) having an additional chrome-look coating is laid in or laminated in-mold, which film represents the decorative element (5) by itself and is shaped in terms of contour and follows the back-side depression (4) of the lens (2).
